(19) United States
(12) Patent Application Publication
(10) Pub. No.: US 2005/0202834 A1
(43) Pub. Date: Sep. 15, 2005

(54) System and method for determination of meeting place utilizing telephone auto location system

(76) Inventor: Isaias Sudit, Delray Beach, FL (US)

Correspondence Address: EDWARDS & ANGELL, LLP, P.O. BOX 55874, BOSTON, MA, 02205, US

(21) Appl. No.: 11/068,536

(22) Filed: Feb. 28, 2005

Related U.S. Application Data
(60) Provisional application No. 60/553,242, filed on Mar. 15, 2004.

(51) Int. Cl. H04Q 7/20

(52) U.S. Cl. 455/456.5; 455/456.1

(57) ABSTRACT

The invention concerns a method for identifying a physical meeting location using an automatic location identification (ALI) equipped wireless device. The method can include the steps of identifying a first physical location of a remote ALI equipped wireless device; calculating a second physical location corresponding to a location of the wireless device; and displaying on said wireless device at least one a bearing and distance from said first physical location to said second physical location. The invention can also include the step of processing the data to identify a third physical location between the first and second physical locations; and displaying on the wireless device information concerning at least the third physical location.

### CROSS-REFERENCE TO RELATED APPLICATIONS

This Application is a Non-Provisional of Provisional (35 USC 119(e)) application 60/553,242 filed on Mar. 15, 2004.

### BACKGROUND OF THE INVENTION

The inventive arrangements relate generally to wireless devices and more particularly to wireless devices with automatic location identification capabilities for determining a convenient meeting place between two locations.

In June 1996, the Federal Communications Commission (FCC) set in place a two-phase plan for implementing wireless 911 in the United States. Phase I, which was originally to have been implemented by April 1998, required callback numbers and cell site sector information about each incoming wireless 911 call. Cell phones that met the Phase I requirements provided a general indication of the caller's location, although the area may be as large as 100 square miles.

Phase II, which was originally scheduled to have been implemented by October 2001, required wireless carriers to provide automatic location identification (ALI) for each wireless 911 call. The plan included a requirement to provide wireless location accuracy for 95% of the callers within a radius of 150 meters or better. The Phase II portion of the plan was intended to enable improved emergency response in connection with 911 calls. The ALI technology necessary to implement Phase II has been delayed in many instances, but is now being deployed in various locations with the expected improvement in emergency response.

There are two basic methods by which wireless position information can be determined. One approach determines a cell phone position by measuring angle of arrival (AOA) and time of arrival (TOA) of cell phone signals at multiple fixed base stations. This approach is essentially a network-based solution. Still, there are a number of problems associated with such network-based solutions. These problems are mainly related to the vagaries of signal propagation, base station availability and infrastructure costs. An alternative approach makes use of the existing global positioning system (GPS) infrastructure. The GPS based approach incorporates a GPS system into each cell phone and relies upon the phone to determine its location for itself. GPS based systems have their own set of problems that mainly relate to GPS satellite acquisition and cold start delays.

The most advanced ALI systems are those that rely on a combination of both the network based and GPS based solutions. Such systems collect GPS measurements and network measurements and send the measurement data to the position determination entity. The position determination entity then processes the measurements to produce the most accurate location information based on available data.

Currently, ALI technology is commercially available from a number of different technology developers. For example, Qualcomm, Inc. of San Diego, Calif. and SnapTrack, Inc. of Campbell, Calif. offer commercially proven GPS-based positioning solutions for third generation wireless (3G). These systems are available for a variety of different air interfaces including CDMA and GSM. Further, they offer commercially available chipsets that can be integrated in cell phones. Also, rather than requiring modification of each base station, a database is constructed at a position determination entity that contains the precise location of each base station.

Aside from the obvious benefits ALI offers with regard to improving emergency responsiveness, the new technology has also created many opportunities for new and interesting applications that make use of the ALI data. These applications offer revenue-generating products and services that are of potential interest to a range of markets including entertainment, fleet management, and security.

### BRIEF SUMMARY OF THE INVENTION

The invention concerns a method for identifying a physical meeting location using an automatic location identification (ALI) equipped wireless device. The method can include the steps of identifying a first physical location of a remote ALI equipped wireless device; calculating a second physical location corresponding to a location of at least a second wireless device; and displaying on the first wireless device at least one of a bearing and distance between first physical location and the second physical-location. The invention can also include the step of processing the data to identify a third physical location between the first and second physical locations, and displaying on either wireless device information concerning the third physical location.

One aspect of the invention is that it identifies points of interest within a predetermined distance of the third physical location. The method also includes the step of displaying on the wireless device information concerning the various points of interest relative to the third physical location. These points of interest can include auto services establishments, travel destinations, shopping, financial institutions or establishments that serve food and/or beverages.

Another aspect of the invention includes the step of communicating data from the wireless device to a remote server identifying one or both of the first and second physical locations. In that case, the method can also include communicating data concerning the third physical location from the remote server to the wireless device. The method can also include communicating a notification to the wireless device from the remote server indicating that data concerning the third physical location is available. Further, data concerning the third physical location can be selected to include at least one point of interest within a predetermined distance from the third physical location. The data concerning the at least one point of interest can also be communicated from a remote server to the wireless device. Advantageously, the point of interest can be selected so as to include an auto services establishment, a travel destination, a shopping destination, financial institutions or a location that serves food and/or beverages.

### BRIEF DESCRIPTION OF THE DRAWINGS

FIG. 1 is a schematic drawing of a wireless automatic location identification (ALI) system in accordance with the invention;

FIG. 2 is a flow chart of the process for determining a location in accordance with the invention;

FIG. 3 is a front elevation view showing a first screen displayed on a wireless device in accordance with the invention;

FIG. 4 is a front elevation view showing a second screen displayed on a wireless device in accordance with the invention;

FIG. 5 is a front elevation view showing a third screen displayed on a wireless device in accordance with the invention;

FIG. 6 is a front elevation view showing a fourth screen displayed on a wireless device in accordance with the invention;

FIG. 7 is a front elevation view showing a fifth screen displayed on a wireless device in accordance with the invention;

FIG. 8 is a front elevation view showing a sixth screen displayed on a wireless device in accordance with the invention;

FIG. 9 is a front elevation view showing a seventh screen displayed on a wireless device in accordance with the invention;

FIG. 10 is a front elevation view showing an eighth screen displayed on a wireless device in accordance with the invention; and

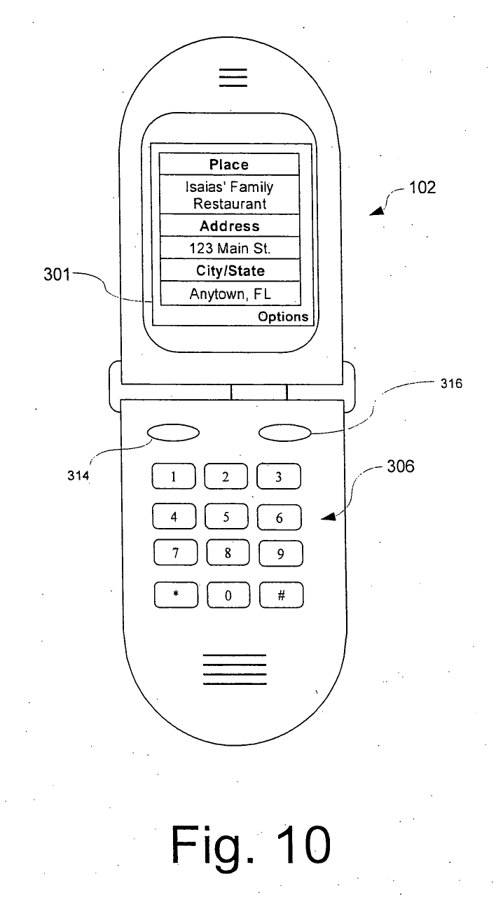

FIG. 11 is a front elevation view showing a ninth screen displayed on a wireless device in accordance with the invention.

### DETAILED DESCRIPTION OF THE INVENTION

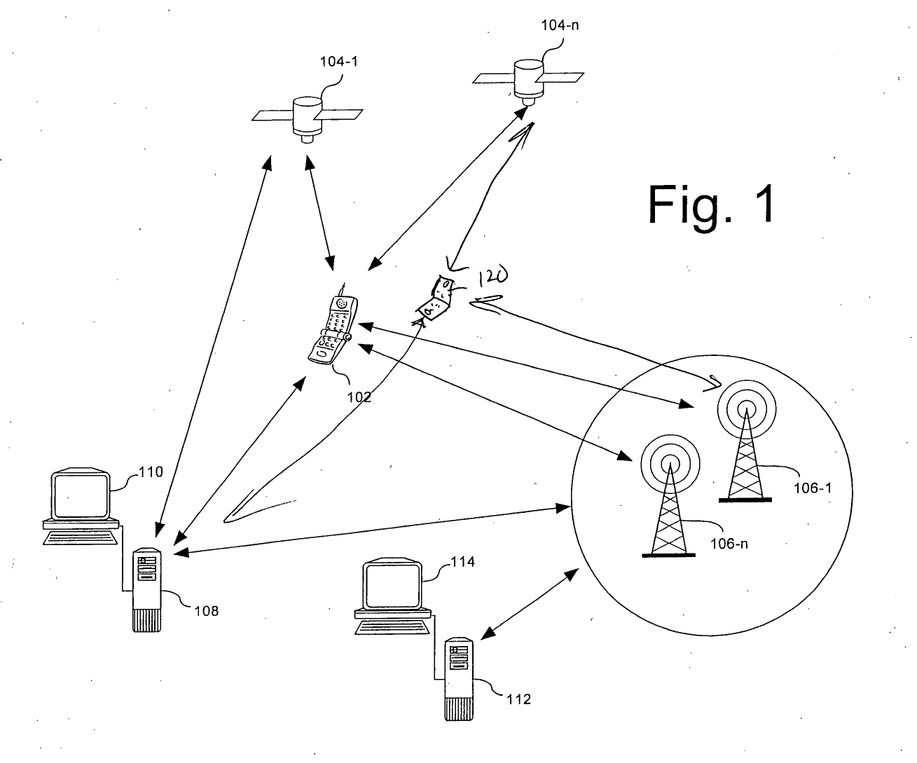

FIG. 1 is a drawing that is useful for understanding the operation of a wireless automatic location identification system in accordance with the inventive arrangements. As illustrated therein, an automatic location identification (ALI) system can rely on a combination of both network based and GPS based solutions. Such systems collect GPS measurements and network measurements and send the measurement data to the position determination entity. A server can then process the measurements to produce the most accurate location information based on available data.

More particularly, FIG. 1 shows that a conventional network based ALI solution can automatically identify a physical location of a wireless device 102 or 120 by measuring angle of arrival (AOA) and time of arrival (TOA) of cell phone signals at multiple fixed base stations 106-1, 106-n. The wireless device 102 can be a wireless PDA, cell phone, laptop computer, or any other device incorporating suitable processing and communication circuitry. The fixed base stations 106-1, 106-n can be in communication with a server 108, which can calculate a physical location of the wireless device 102. For example, the physical location can be calculated based on AOA and TOA information.

The server 108 can communicate with the base stations 106-1, 106-n using any suitable means. For example, a conventional telephone network, high-speed data line, wireless link, or a combination of the foregoing can be used. Base stations 106-1, 106-n can provide a data link between the wireless device 102 and the server 108. The server 108 can be controlled by a workstation 110 or similar user interface device.

Due to the vagaries of signal propagation, base station availability and other infrastructure limitations, the physical location determined using the network-based solution can be inaccurate in certain instances. In order to improve overall accuracy, the network-based approach can also generate location information for the wireless device 102 using an alternative approach. For example, the wireless device can include an onboard global positioning system (GPS) and associated processing circuitry/software. The GPS system can be incorporated into each wireless device 102 and such system can use signals from a plurality of GPS satellites 104-1, 104-n to independently determine the physical location of the device. The GPS based location information thus obtained can be forwarded to the server 108 through the one or more base stations 106-1, 106-n. Likewise, server 108 can communicate location information to an emergency or 911 services operator. The ALI data provided by the server can be highly accurate data regarding the location of the wireless device 102 based on a combination of the network data and GPS data.

A geographic coordinate map database such as those known from NAVTEQ, MapQuest and Map Point is stored in a database associated with application server 108 or 112. These databases contain both graphic maps and the underlying geographic coordinate location of points on the maps. Additionally, as an overlay, points of interest such as restaurants, stores, landmarks (museums, theme parks, statues, or the like) are stored at the server with their associated geographical coordinates. In a preferred embodiment, a geographic coordinate is the longitude, latitude or street address of interest.

For the purposes of the present invention, the precise manner by which ALI information is determined is not critical. The system can rely primarily on GPS, network measurements or a combination of the two. Accordingly, the foregoing description represents merely one possible method by which such ALI can be determined. Other methods are also possible and are also intended to be within the scope of the invention. Furthermore, for ease of description, the system and method are described with reference to two wireless devices. However, the system can also operate utilizing three or more wireless devices and determining a prearranged mutually convenient location.

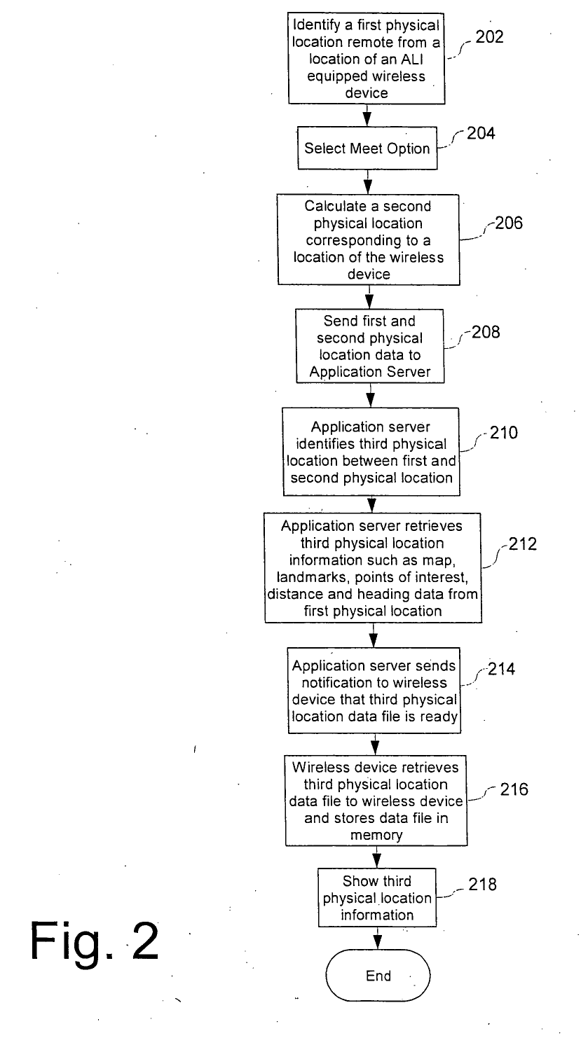

FIG. 2 is a flow chart that is useful for understanding the process of the present invention. The process in FIG. 2 can begin in step 202 when a user selects a “find people” option on a wireless device, indicating a desire to determine a physical location of a remote wireless device 120.

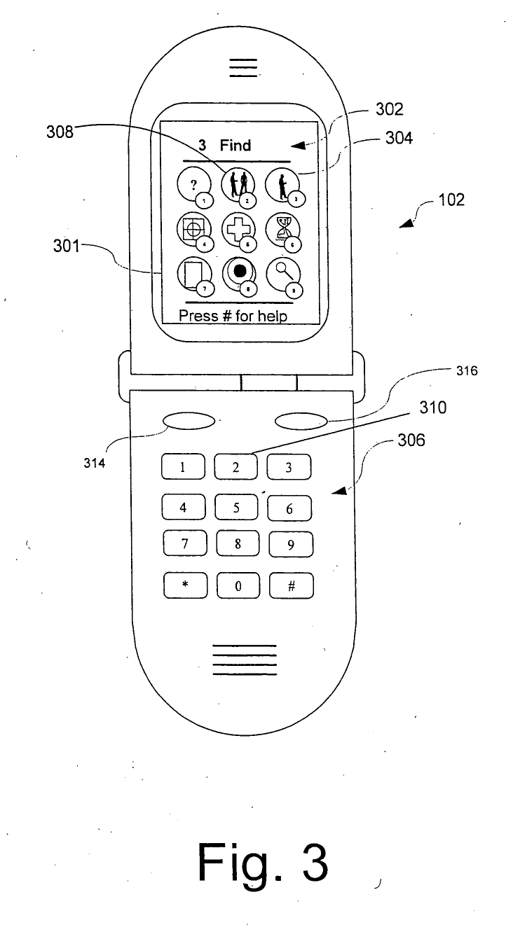

Step 202 can be better understood with reference to FIGS. 3-5. FIG. 3 shows wireless device 102 can have a display 301 and a keypad 306 for entering data. A series of icons 304, 308 are presented on the display 301 to identify user options. The display 301 can be a touch screen display, thereby permitting direct activation of associated service by touching each icon on screen. Alternatively, each icon can be identified with a number identifying a corresponding key number corresponding to a key on keypad 306. Pressing the corresponding key can activate the service identified by the associated icon. In either case, the process begins in step 202 by a keystroke or touching of touch screen display to activate the “find people” option.

In FIG. 3, the icon 308 represents the “find people” option and the corresponding key for icon 304 is key number 2, identified here with reference number 310. Thus, in step 202, the user selects the “find people” option by pressing key number 2. Alternatively, in the case of a touch screen display, the user could tap on the icon 308.

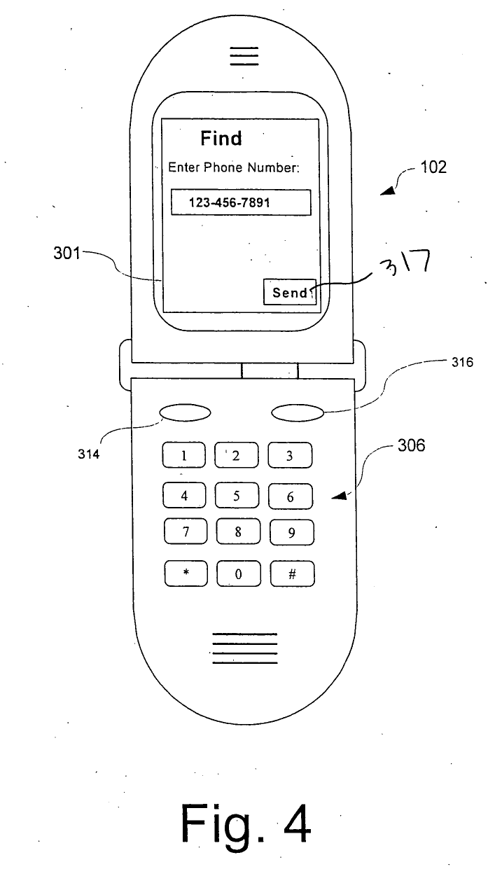

In FIG. 3, the “find people” option has already been activated as indicated by command line 302. Once the “find people” option is selected by a user input as shown in FIG. 3, a FIND screen shown in FIG. 4 prompts the user for a telephone number of the wireless device 120 that is to be located. The telephone number can be identified from a stored list or can be entered manually. Once the number is entered, a “send” command can be input by the user, by any suitable means such as by striking soft key 316 or an icon 317 on display 301. This command can be communicated to an application server 112 and will cause information identifying the location of a remote ALI enabled wireless device 120 to be determined.

For example, this can be accomplished using commercially available network based and GPS based systems as previously described in relation to FIG. 1. The location information thus determined can be communicated from server 108 or from the remote wireless device to an application server 112, which can in turn communicate the information to the wireless device 102. The application server 112 can include at least one user interface 114 for configuring the server and monitoring its operation.

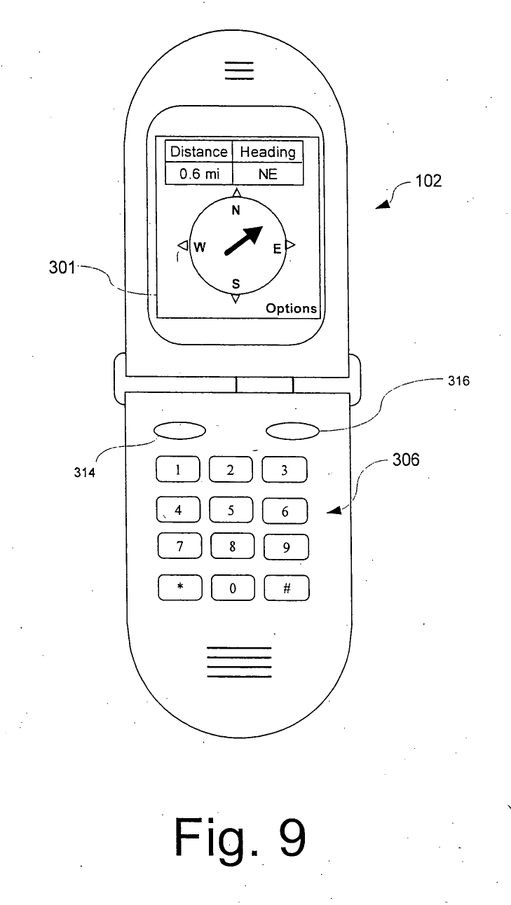

The application server 112 can build a map file based at least in part on the location data communicated from server 108 and the stored coordinate map data. Once this task is complete, the application server 112 can notify the wireless device 102 that the map file is available. The notification can be communicated to the wireless device through any one of the base stations 106-1, 106-n. The application server can also calculate, using planar geometry by way of non-limiting example, bearing and distance information from the first wireless device 102 relative to the second wireless device 120. This information can also be communicated from the application server 112 to the first wireless device 102. The bearing and distance information can be displayed in a manner similar to that shown in FIG. 9.

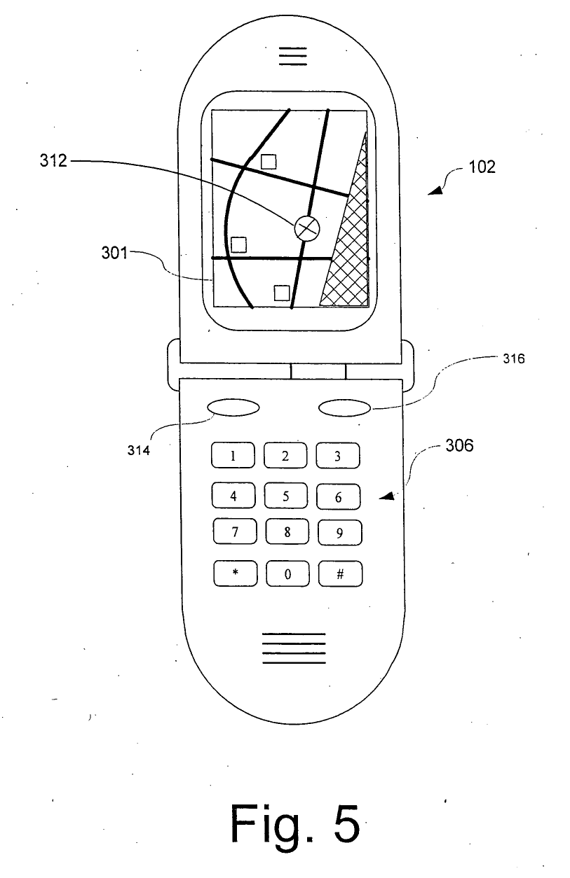

The wireless device 102 can retrieve the physical location data and the map file to the wireless device through any of the base stations 106-1, 106-n. If the calculation cannot be performed in real time, then during the period when the location of the wireless device is being calculated and the map file is being created, the wireless device 102 can display a suitable message to the user. For example the display 301 can indicate that the user is to wait while the requested information is being assembled. Finally, the map file can be automatically displayed as shown in FIG. 5. Using the map file, the display 301 can show various man-made and natural features. For example, the map file can include roads, selected buildings, and bodies of water. The map file can also include a marking 312 to indicate the location of the wireless device 120, or both devices 102, 120 relative to each other and/or such man-made and natural features.

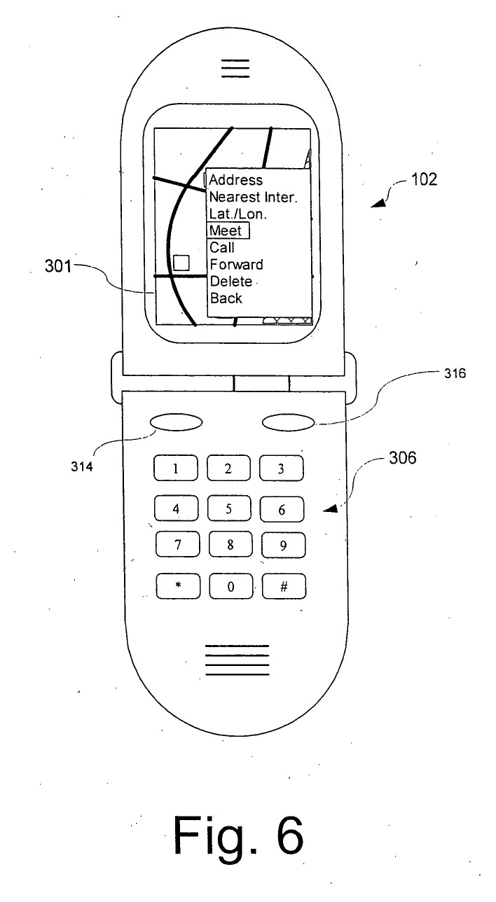

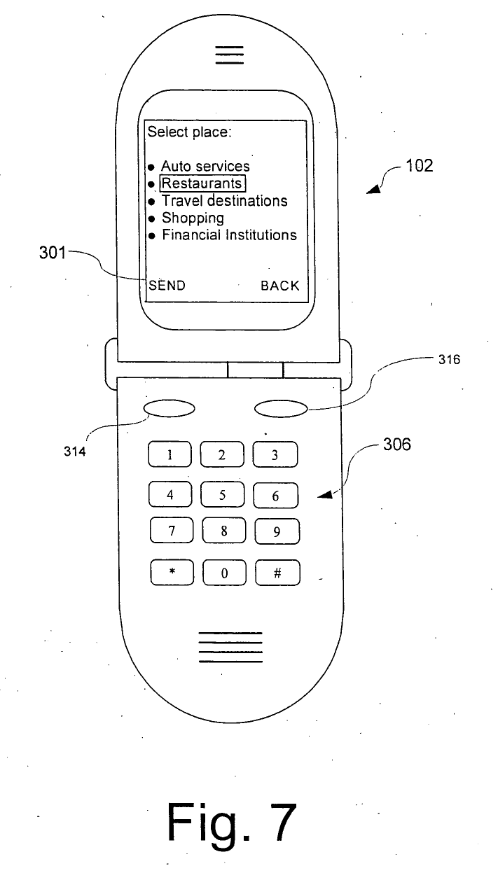

In step 204, the “meet” function can be selected by a user. For example striking soft key 316 can cause a menu to be displayed as shown in FIG. 6. The menu can include several menu commands including a “meet” command as shown. Users can select different commands by using one or more soft keys 314, 316 on the wireless device. Selecting the meet command can cause the screen in FIG. 7 to be displayed. The screen in FIG. 7 prompts a user to select a type of location, such as auto service, restaurant, and travel destination, shopping or financial institution at which a meeting is to take place. Once again, the user can select the desired option using the soft keys 314, 316. In FIG. 7, the selected location type is Restaurant. The user can then continue by pressing a soft key 314 corresponding to the SEND command.

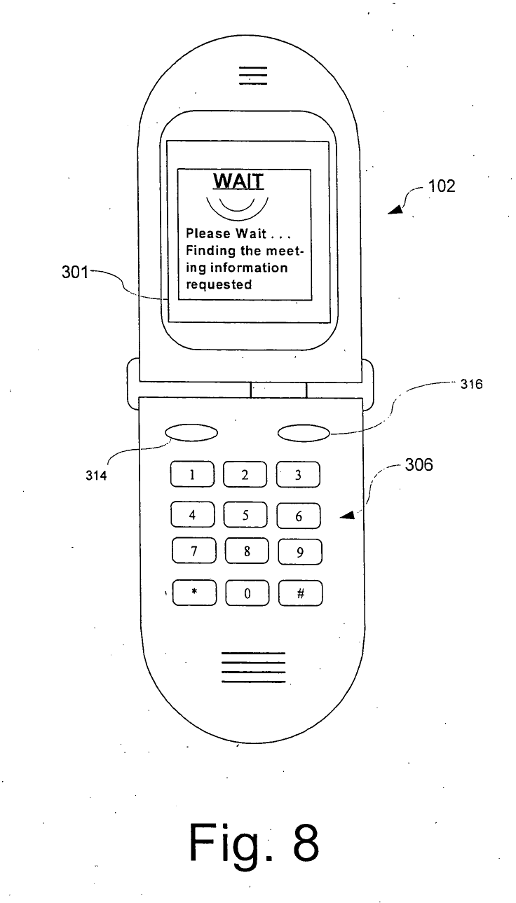

Selecting the SEND command acts as a request to server 112 to determine a restaurant, by way of example, convenient for meeting. The location corresponding to the location of the wireless device 102 can be determined in step 206. This can be accomplished in a manner similar to that already described above in relation to the remote wireless device 120. Thereafter, the location of the remote wireless device 120 (first physical location) and the wireless device 102 (second physical location) can be communicated in step 208 to the application server 112. Again, if not accomplished in real time, then during this period of time, a screen can be displayed as shown in FIG. 8. The screen can advise the user to wait while the information concerning the location of wireless device 102 is retrieved.

In step 210, the application server 112 can identify a third physical location between the first and second physical location. For example, application server 112 compares the location of the first wireless device 102 to the location of the second wireless device 120. It then determines a distance between the two as well as bearing to determine, in a preferred but not limiting embodiment, a straight-line distance between the two. Once distance has been determined, server 112 calculates a midpoint, or some other point, as the general meeting point. For the purposes of this description, “midpoint” means any calculable point between the wireless devices. Server 112 then determines a radius representing a geographical area about the selected midpoint. In a preferred non-limiting embodiment, the third physical location can represent approximately a midpoint between the first and second physical locations. In step 212, the application server 112 can retrieve third physical location information as requested. Such information can include map data substantially corresponding to the radius, landmark points of interest within the radius, distance and heading data. The third physical location data will also specifically include information concerning locations of the type as selected by the user in FIG. 7. For example it can include a listing of restaurants within the predetermined distance from the third physical location.

In step 214, the application server 112 can send a notification to the wireless device 102 that the third physical location data is ready for retrieval. In step 216, the wireless device 102 can retrieve the information and store it in memory. The retrieved information can include several restaurants within the predetermined area by way of example. Utilizing soft keys 306, 314, 316 or an icon driven system on display 301, the user of wireless device 102 can select one of the listed restaurants by way of example if restaurants were selected in step 210. Once a specific restaurant is provided, application server 112 provides a'street address and phone number for the restaurant. This information may be stored in a database at server 112 or may be retrieved from a third party data source across the Internet.

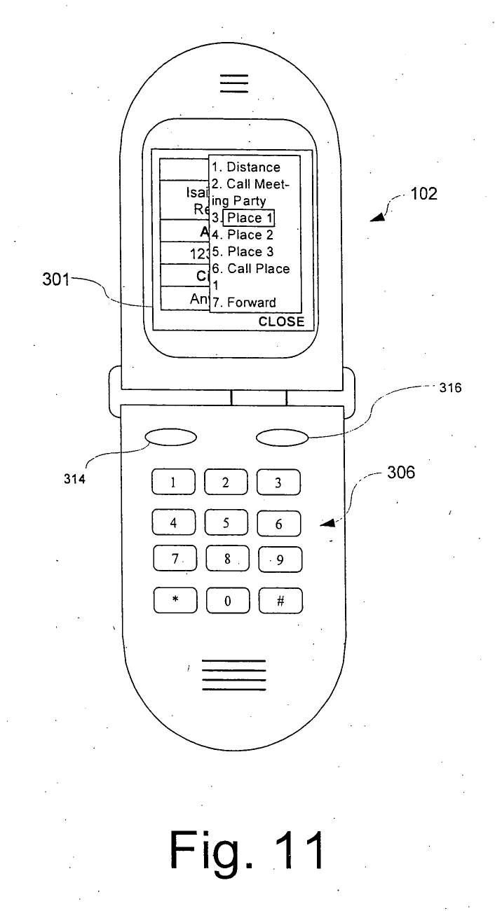

Finally, in step 218, the third physical location data can be displayed. For example, in FIG. 9 heading and distance information from the wireless device 102 to the third physical location can be displayed. By using the soft key, a user can select additional options as shown in FIG. 11. For example, such options can include the name and address of a particular type of point of interest, such as restaurants within a predetermined distance from the third physical location.

Notably, once the physical location data and the map file for the third physical location have been received by the wireless device 102, it can be forwarded to other devices such as wireless device 120 by wireless data communication between the devices 102, 120. Thus, a user can select a forward command that will cause the map file and or the physical location data to be forwarded to another device which may or may not have ALI capability. The data can be sent to other devices in the form of a conventional email or by using short message service (SMS) as is known in the art. Further, instant messaging services are becoming more widely available and will soon be implemented in wireless networks such as the one shown in FIG. 1. The physical location data can also be forwarded to third parties using such instant messaging.

For ease of explanation, it is assumed, that the user wireless device 102 has the authorization of user wireless device 120 to arrange the meeting. However, in a preferred embodiment, in step 202, server 112 would notify wireless device 120 that a third party at the given identification number of wireless device 102 is requesting their location. If it is the first occurrence of such a request, the operator of wireless device 120 shall have the option of denying the request on a request by request basis, accepting the request on a request by request basis, permanently blocking the request from that particular identification number, or permanently allowing the request from that identified wireless device. This selection is stored at application server 112 to allow access in accordance with the instructions from the object wireless device 120.

Furthermore, as discussed in connection with FIGS. 5 and 9, server 112 is capable of determining a bearing for each wireless device 102, 120 and providing a map corresponding to the location of a desired wireless device or the midpoint location of interest at the wireless device. By periodically refreshing the data, as either wireless device moves, server 112 can provide a new map and bearing corresponding to a new location of a wireless device and its destination point. In this way, wireless device 102, by way of example, can provide continuous guidance while traveling to the meeting point.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims. For example, instead of the geographical calculation concerning location, distance between location, bearing, and/or map generation being performed at the remote server, one or more of such calculations can be performed directly at the wireless device. Furthermore, all functionality could be performed at a single server 108 rather than dividing the functionality.

Furthermore, the above embodiment was utilized to wireless devices. However, the invention works equally well utilizing a single wireless device and a known address or geographical location of the entity with which the wireless device user wishes to meet. For example, a wireless device user meeting a friend or relative and knowing the street address of that friend or relative and sending the information to their house phone or computer.

1. A method for identifying a physical meeting location using an automatic location identification (ALI) equipped wireless device comprising the steps of:
identifying a first physical location remote from a location of an ALI equipped wireless device;
calculating a second physical location corresponding to a location of said wireless device; and
displaying on said wireless device at least one a bearing and distance from said first physical location to said second physical location.

2. The method according to claim 1 further comprising the step of processing said data to identify a third physical location between said first and second physical locations; and
displaying on said wireless device information concerning at least said third physical location.

3. The method according to claim 2 further comprising the step of identifying at least one point of interest within a predetermined distance of said third physical location.

4. The method according to claim 3 further comprising the step of displaying on said wireless device information concerning said at least one point of interest.

5. The method according to claim 3 further comprising the step of selecting said at least one point of interest to include an establishment that serves at least one of food and beverages.

6. The method according to claim 1 further comprising the step of communicating data from said wireless device to a remote server identifying at least one of said first and second physical locations.

7. The method according to claim 2 further comprising the step of communicating data concerning said third physical location from a remote server to said wireless device.

8. The method according to claim 7, further comprising the step of communicating a notification to said wireless device from said remote server indicating that data concerning said third physical location is available.

9. The method according to claim 2 further comprising the step selecting said data concerning said third physical location to include at least one point of interest within a predetermined distance from said third physical location.

10. The method according to claim 9 further comprising the step of communicating data concerning said at least one point of interest from a remote server to said wireless device.

11. The method according to claim 9 further comprising the step of selecting said point of interest to include a location that serves at least one of food and beverages.

12. The method according to claim 1, wherein said first physical location corresponds to a second wireless device.

13. The method according to claim 12, wherein at least one of said wireless device and second wireless device is a cell phone.

14. The method according to claim 1, further comprising repeatedly calculating said second physical location and displaying on said wireless device at least one of a bearing and a distance at periodic intervals.

15. The method according to claim 2, wherein said first physical location corresponds to a second wireless device.

16. The method according to claim 15, further comprising the step of said wireless device communicating said third physical location to said second wireless device.

17. A system for identifying a physical meeting location between a first physical location and a second remote physical location comprising:
a first automatic location identification equipped wireless device;
a second automatic location identification equipped wireless device; and
a remote server in communication with said first remote wireless device and said second remote wireless device, calculating a first physical location remote from said server corresponding to a location of said first wireless device, calculating a second physical location corresponding to a location of said second wireless device, comparing said first physical location to said second physical location and determining a third physical location between said first physical location and said second physical location, and communicating said third physical location to at least one of said first wireless device and said second wireless device.

18. The system of claim 17, further comprising a database associated with said server, said database including a coordinate based map, and point of interest information; said server determining said third physical location by comparing said first physical location to said second physical location and determining a midpoint location corresponding to said third physical location between said first physical location and said second physical location.

19. The system of claim 18, wherein said wireless device displays at least one of said first and second physical location, and said third physical location, a map and a bearing between a physical location of said first or second wireless device and said third physical location.

20. The system of claim 17, wherein at least one of said first wireless device and said second wireless device is a cellular telephone.

21. The system of claim 18, wherein said database includes points of interest and associated physical locations of each respective point of interest.

22. The system of claim 21, wherein said server calculates a geographical area about said third physical location and communicates points of interest within said geographical area to at least one of said first wireless device and said second wireless device.

23. The system of claim 22, wherein said first wireless device communicates at least one of said points of interest to said second wireless device.
